(19) United States
(12) Patent Application Publication
(10) Pub. No.: US 2010/0178519 A1
(43) Pub. Date: Jul. 15, 2010

(54) COMPOUND COATING FOR WOOD

(75) Inventors: Franz HEIBERGER, Augsburg (DE); Hermann SCHLAEFFER, Neusaess (DE)

Correspondence Address: SCULLY SCOTT MURPHY & PRESSER, PC, 400 GARDEN CITY PLAZA, SUITE 300, GARDEN CITY, NY, 11530, US

(73) Assignee: KEIMFARBEN GMBH & CO. KG, Diedorf (DE)

(21) Appl. No.: 12/687,203

(22) Filed: Jan. 14, 2010

(30) Foreign Application Priority Data
Jan. 14, 2009 (EP) 09 150 512.3

(51) Int. Cl. B32B 27/08; C08K 3/22; C08K 3/26; C08K 3/30; B05D 1/36

(52) U.S. Cl. 428/447; 524/430; 524/425; 524/423; 427/408

(57) ABSTRACT

The present invention relates to a compound coating for wood comprising an alkyd resin undercoat and a siliceous coating applied on top of this undercoat. The alkyd resin undercoat may be obtained from a coating material comprising a long oil alkyd resin and a mineral component. The siliceous coating to be applied on top of the undercoat is obtainable from a coating material comprising water glass or a mixture of silica sol and water glass having a ratio of 5 to 30 mol of SiO₂ per mol of alkali oxide and a mineral component.

The present invention relates to a compound coating for wood comprising an alkyd resin undercoat and a siliceous coating applied on top of this undercoat as well as a kit consisting of an alkyd resin coating material and a siliceous coating material and a method for applying said coating.

### TECHNICAL BACKGROUND

Alkyd resins generally are polyester compounds of polyvalent acids (e.g. phthalic acid, isophthalic acid, maleic acid) and polyhydric alcohols (especially glycerol or pentaerythritol), excess OH groups being esterified with unsaturated fatty acids. The prior art knows numerous methods of preparing alkyd resins. For example, alkyd resins may be obtained by transesterification of a drying oil with an excess of polyol and subsequent reaction with an acid anhydride. Other methods start from the acid, the alcohol and the corresponding fatty acid mixture.

The fatty acid ratio is indicated on the basis of the weight ratio of the oil and is called “oil length”. A short oil alkyd resin has an oil length of typically 20 to 40%, a middle oil resin has one of 40 to 60% and the term long oil alkyd resin is generally used above 60%. The higher the oil length, the lower the degree of polymerisation of the polyester component and the higher the ratio of fatty acids per polyester molecule.

Lacquers on an alkyd resin basis are often used for coating wood. Wood is a comparatively soft substrate that expands and contracts. For satisfactory adhesion to wood, any coating must therefore have a certain flexibility which is the case with alkyd lacquers.

However, alkyd resins are not UV resistant. Therefore, alkyd lacquer coatings on wood located outdoors must be renewed on a regular basis.

Even though siliceous paints as used outdoors especially for coating mineral substrates or metal surfaces are UV resistant and have excellent stability, they are mechanically comparatively rigid and therefore generally do not adhere to wood in the long term. A possible solution to this problem is the use of an undercoat with higher flexibility which serves as an adhesive between the soft wood and the hard silicate paint.

However, alkyd lacquer coatings are generally unsuitable as an undercoat for siliceous paints, because the silicate paint catalyses the saponification of the alkyd resin. This may lead to degradation of the alkyd resin before it cures. For this reason, such combinations do not adhere to wood in the long term.

### PROBLEM TO BE SOLVED

In view of the problems described, the present invention has the object of providing a coating for wood that is UV-resistant and adheres stably.

### DISCLOSURE OF THE INVENTION

Surprisingly, it has been found that specific combinations of an alkyd resin undercoat and a silicate paint on wood are stable and permanent.

Accordingly, the present invention provides a compound coating of an alkyd resin undercoat and a siliceous coating as well as the corresponding combination of a suitable alkyd resin coating material and a siliceous coating material in the form of a kit. In addition, the invention relates to a method for applying the compound coating according to the invention.

Advantages of the compound coating according to the invention are the longer lifetime in comparison with a normal alkyd coating (renovation interval 7 to 15 years or more instead of 3 to 6 years in case of a pure alkyd coating). In addition, it is no longer necessary to strip the old alkyd coating when renovating and the amount of solvent released is reduced. Finally, the coating of the invention also provides novel possibilities for fashioning surfaces.

Alkyd Resin Coating Material

The alkyd undercoat may be obtained by applying an alkyd resin coating material comprising the following components:

(A-1) a long oil alkyd resin;

(A-2) a mineral component; and

(A-3) a solvent.

The alkyd resin coating material to be used according to the invention may preferably also contain agents (A-4) that accelerate drying.

(A-1) Long Oil Alkyd Resin

Component (A-1) is a long oil alkyd resin having an oil length of at least 60%, for example in the range between 60 and 90%, especially 70 to 80%. The oil used for this purpose is a semi-drying or drying oil having an iodine number according to DIN 53241-1 of more than 100, preferably more than 130 and especially preferably of more than 160. Safflower oil, linseed oil, dehydrated castor oil, sunflower oil, soy bean oil, tung oil or fish oils may be mentioned as examples of oils with a suitable fatty acid composition. Alkyd resins on a tall oil fatty acid basis may also be used. Component (A-1) is preferably contained in the undercoat in a ratio of 40 to 60 wt.-%.

At an oil length below 60% and/or an iodine number of the oil below 100, the alkyd resin does not dry fast enough and the alkyd resin undercoat may saponify when exposed to the silicate paint, resulting in insufficient stability of the compound coating.

Suitable alkyd resins are available commercially, for example under the designation Setalin or Ural=Jägalyd.

(A-2) Mineral Component

Component (A-2) consists of mineral particles and acts as an adhesive. It is required to adhere the silicate coating to the undercoat layer and is preferably contained in the alkyd resin coating material in a ratio of 5 to 25 wt.-%. Smaller ratios may result in reduced adhesion of the silicate coating to the undercoat. Especially preferred are ratios of 10 to 15 wt.-%. The particle size may be 1 to 80 um, for example, 4 to 10 um being preferred.

Mineral particles as typically used as filler material, dulling agents or pigments may be used as component (A-2). Particles of silica or a siliceous material, for example precipitated SiO₂, kieselguhr (diatomaceous earth) or silicate minerals such as mica, kaolinite, muscovite or chlorite may be mentioned as examples thereof.

Carbonate minerals such as calcites or oxides such as alumina, calcium oxide, titanium dioxide, magnesium oxide, zirconium oxide and/or boron oxide are also suitable.

Moreover, oxidic pigments, for example on an iron oxide basis, may also be used. In addition, barite or zinc sulfide may be used.

Component (A-2) may also consist of a mixture of different minerals, for example a mixture of different layered silicates. Preferably, precipitated SiO₂ or kieselguhr are used as component (A-2).

(A-3) Solvent

In general, any solvent suitable for alkyd resin lacquers may be used as component (A-3). A typical example that may be mentioned are hydrocarbon-based solvents such as white spirit.

(A-4) Drying Accelerator

To ensure good stability of the alkyd undercoat against degradation by ester hydrolysis, the alkyd resin should dry quickly. To accelerate the drying process, the alkyd resin coating material preferably contains a component (A-4) which catalyses the radical cross-linking of the unsaturated fatty acids. All of the desiccants commonly used for alkyd paints in the prior art may be used for this purpose.

Examples thereof are metal salts soluble in the coating material, especially transition metal salts of organic acids such as cobalt-2-ethyl hexanoate. The agent (A-4) is commonly used in an amount of 0.005 to 0.3 wt.-%, preferably 0.01 to 0.1 wt.-%.

Other Components

The alkyd resin coating material may contain additional components common in the prior art as long as they do not affect the adhesion of the silicate coating. Examples thereof are agents preventing the formation of skin such as 2-butanonoxim or thickeners (e.g. bentonite).

Preparation of the Alkyd Resin Coating Material

The alkyd resin coating material may be prepared by methods known per se by dilution of component (A-1) with the solvent (A-3) until the desired viscosity has been achieved and subsequent stirring in of the mineral component (A-2).

Silicate Coating Material

The silicate coating may be obtained by applying a silicate coating material to the alkyd resin undercoat. According to the invention, a siliceous coating material is used which comprises
(B-1) water glass or a mixture of silica sol and water glass, the molar ratio of SiO₂ to alkali oxide being 5 to 30 mol of SiO₂ per mol of alkali oxide; and
(B-2) a mineral component.

Optionally, a polymer (B-3) and/or an organic ammonium compound (B-4) may also be contained. Other optional components comprise pigments, thickeners and dispersants as well as water as a solvent. Silicate paints which may be used according to the invention are described, for example, in DE 100 01 831 and EP 1222 234, respectively.

Component (B-1)

The molar ratio of SiO₂ to alkali oxide in the water glass or in the mixture of water glass and silica sol in component (B-1) is 5 to 30 mol of SiO₂ per mol of alkali oxide, preferably 15 to 25 mol of SiO₂ per mol of alkali oxide and especially preferably 20 mol of SiO₂ per mol of alkali oxide. As is common in silicate analysis, the amounts of the components have been specified on the basis of the oxides even if compounds such as silicates or similar substances are actually present.

At a molar ratio below 5 mol of SiO₂ per mol of alkali oxide, the initial water resistance and adhesion to the undercoat deteriorate. In addition, such a high content of alkali oxide favours saponification of the alkyd resin which reduces the stability of the undercoat.

Water glass is defined as melts of alkali silicates and aqueous solutions thereof which may be obtained from alkali carbonates and SiO₂ and which have solidified in a manner similar to glass. In the siliceous coating material, the water glass or the mixture of water glass and silica sol acts as a binder and brings about the specific characteristics of siliceous coating materials.

The coating material is silicified by the evaporation of water and reaction with carbon dioxide, i.e. the binder is converted into a water-insoluble siliceous network which may include the components of the substrate. This results in a very hard coating having high gas permeability. The water glass used is generally prepared by melting quartz sand together with alkali carbonate.

The alkali oxide of the water glass is, for example, lithium, sodium or potassium oxide. Potassium oxide is preferred, because it has a lower tendency towards efflorescence than sodium oxide and is less expensive than lithium oxide. The alkali oxide is preferably contained in an amount of 0.5 to 3 wt.-%, especially preferably 0.5 to 0.8 wt.-% based on the total weight of the siliceous coating material. An alkali oxide content of 0.5 wt.-% is most preferred.

Silica sol is defined as an aqueous solution of colloidal silicic acid. Preferably, an alkaline silica sol is used. Moreover, a solid content of 10 to 50% is preferred. In addition, the silica sol advantageously has a mean particle size of <10 nm. The silica sols used are also preferably characterised by a very even and fine distribution spectrum.

The water glass or the mixture of water glass and silica sol is preferably contained in an amount of 3 to 40 wt.-%, especially preferably 15 to 35 wt.-% based on the total weight of the siliceous coating material. If a mixture of water glass and silica sol is used, the silica sol may be present in a ratio of 3 to 30 wt.-% based on the total weight of the siliceous coating material.

Component (B-2)

The siliceous coating material that may be used in accordance with the invention comprises a mineral component (B-2). In general, the same materials are suitable for component (B-2) as may be used for the mineral component (A-2) of the alkyd resin coating material.

The mineral component (B-2) preferably comprises one or more fillers common in the prior art, preferably in an amount of 10 to 45 wt.-% of filler(s) based on the total weight of the siliceous coating material.

A particularly smooth and shiny surface of the silicate material is obtained if component (B-2) contains a crystalline filler from the class of calcites.

In order to increase the crack strength of the coating obtained with the siliceous coating material, it is advantageous for component (B-2) to contain platelet-shaped substances such as layered silicates (mica, kaolinite, muscovite, chlorite) as a filler. If component (B-2) contains such platelet-shaped substances, their ratio is preferably 5 to 25 wt.-%, especially preferably 10 to 20 wt.-%, based on the total weight of the siliceous coating material.

In addition, component (B-2) may contain barite as a filler. If component (B-2) contains barite, its ratio preferably is 3 to 15 wt.-%, especially preferably 9 to 11 wt.-%, based on the total weight of the siliceous coating material.

Other possible mineral components which may be used as mineral component (B-2) on their own or in an admixture with each other and/or in an admixture with the fillers listed above comprise oxides from the group consisting of alumina, calcium oxide, titanium dioxide, magnesium oxide, zirconium oxide and/or boron oxide as well as mineral pigments for adjustment to a desired colour.

Mineral oxides, especially oxides having a rutil or spinell structure such as iron oxides are advantageously used as pigments. If component (B-2) contains pigments, their ratio is preferably 5 to 20 wt.-% based on the weight of the coating material.

Polymer (B-3)

The siliceous coating material that may be used according to the invention may further contain a polymer. Siliceous coating materials containing a polymer are especially used as dispersion silicate paints. The addition of a polymer results in higher elasticity of the coating obtained after silicification which is advantageous for the adhesion to the alkyd undercoat.

According to the DIN regulation 18 363, para. 2.4.1, dispersion silicate paints must not contain more than 5% of organic elements maximum. Irrespective of this DIN guideline, however, a polymer content of up to 15 wt.-% based on the total weight of the siliceous coating material, especially 1 to 15 wt.-%, is advantageous. A polymer content of 3 to 10 wt.-% is especially preferred. Generally, the polymer is incorporated into the siliceous coating material in the form of a dispersion. The solids content of the polymer dispersion is preferably 20 to 80 wt.-%. Preferably, the polymer is a (meth)acrylate homopolymer or copolymer. A butyl acrylate-methyl methacrylate copolymer is especially preferred.

Ammonium Compound (B-4)

An organic ammonium compound (B-4) may be admixed to the siliceous coating material that may be used according to the invention to prevent gelatinisation. Ammonium compounds suitable for this purpose are described in DE 100 01 831 and comprise compounds of the formula (I):

⁺NR¹R²R³R⁴X⁻ (I)

wherein R¹, R² and R³ independently represent an alkyl group having 1 to 20 carbon atoms which may optionally be substituted with a functional group or hydrogen, R⁴ represents an alkyl group having 1 to 20 carbon atoms, hydrogen or —(CH₂)ₓ—N⁺R⁵R⁶R⁷Y⁻ wherein R⁵, R⁶ and R⁷ independently represent an alkyl group having 1 to 20 carbon atoms which may optionally be substituted with a functional group or hydrogen, and wherein at least one of R¹, R², R³ and R⁴ is not hydrogen, x represents a number between 1 and 6 and X⁻and Y⁻each represent an anion. The functional group as a substituent of the alkyl group may, for example, be a hydroxy group, an amino group, a thiol group, preferably a hydroxy group. The choice of the anion is not particularly limited as long as the effect of the organic ammonium compound is not reduced. For example, the anion may be F, Cl⁻, Br⁻, I⁻or OH⁻.

An organic ammonium compound of the formula (II) is especially preferred:

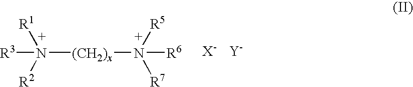

wherein R¹, R², R⁵ and R⁷ each independently represent an alkyl group having 1 to 20 carbon atoms or hydrogen, R³ and R⁶ each independently represent a hydroxy-substituted alkyl group having 1 to 6 carbon atoms, x is a number between 1 and 6 and X⁻ and Y⁻ may be the same or different and each represent an anion, e.g. F, Cl⁻, Br⁻, I⁻ or OH⁻.

The alkyl groups of the formulae (I) or (II) preferably contain 1 to 6 carbon atoms; selected examples are methyl, ethyl, propyl, isopropyl, n-butyl, tert-butyl, pentyl, hexyl and cyclohexyl. Selected examples of a hydroxy-substituted alkyl group having 1 to 6 carbon atoms are hydroxymethyl, hydroxyethyl, 1-hydroxypropyl and 2-hydroxypropyl.

Especially preferred is an organic ammonium compound wherein R¹, R², R⁵ and R⁷ each represent a methyl group, R³ and R⁶ each represent a 2-hydroxypropyl group, x is a number between 1 and 3 and X⁻ and Y⁻ each are OH⁻.

The organic ammonium compound is preferably contained in the siliceous coating material in an amount of 0.1 to 3 wt.-% based on the total weight of the siliceous coating material.

Other Components

The siliceous coating material may contain additional components as long as they are not detrimental to the object of the invention.

Additional components that may be used are especially the additives common in the prior art such as thickeners, hydrophobing agents, dispersants and/or defoaming agents.

Examples for thickeners are polysaccharides, cellulose, bentonite and xanthan. Their content may be 0.1 to 5 wt.-% based on the total weight of the siliceous coating material.

The hydrophobing agent may comprise polysiloxanes and especially amino-functional polysiloxanes, for example. The hydrophobing agent may be present in an amount of 0.1 to 5 wt.-% based on the total weight of the siliceous coating material.

An example of a dispersant that may be used is tetrasodium-N-(1,2-dicarboxyethyl)-N-alkylsulfosuccinamide. The dispersant is preferably present in an amount of 0.1 to 0.5 wt.-% based on the total weight of the siliceous coating material.

Defoaming agents that may be present in the siliceous coating material are hydrophobic silicic acid, liquid hydrocarbons, non-ionogenic emulsifiers and/or synthetic copolymers. The preferred amount of the defoaming agent is 0.1 to 1 wt.-% based on the total weight of the siliceous coating material.

In addition, the siliceous coating material may contain water, preferably in an amount of 20 to 50 wt.-% based on the total weight of the siliceous coating composition.

Preparation of the Siliceous Coating Material

The siliceous coating material to be used according to the invention may be prepared by first dispersing the mineral component (B-2) in water and then adding the organic ammonium compound (B-4), followed by the polymer (B-3) in the form of a dispersion, the latter two being optional. After thorough dispersing, the water glass or the mixture of water glass and silica sol is added, followed by additional optional additives, e.g. a thickener and/or a hydrophobing agent. A dispersion with the preferably highest possible degree of homogeneity is obtained by further stirring.

Alternatively, a siliceous coating material that may be used according to the invention may be prepared as follows: First the water glass or the mixture of water glass and silica sol is introduced and then mixed with the optional organic ammonium compound(s). The mineral component is then added to this mixture. Here it is common to stir in the optional pigments first and then the fillers. Then a polymer dispersion may optionally be stirred in. Finally, further additives such as a thickener and/or a hydrophobing agent may be added.

### EXAMPLE 1

Alkyd Undercoat 1

50 wt.-% of alkyd resin on the basis of tall oil fatty acid (Uralac AD97, manufacturer DSM NeoResins) are diluted with 39.99 wt.-% of white spirit (Varson 40, manufacturer Exxon Mobil Chemical). 10 wt.-% of diatomaceous earth (Dicalite WB 6, manufacturer Dicalite Europe) are then mixed in a dissolver for 30 minutes until a degree of fineness of less than 25 μm has been achieved. The degree of fineness is determined by means of a grindometer.

0.01 wt.-% of cobalt-2-ethyl hexanoate is added as a desiccant.

Silicate Paint 1

A mixture of 3.8 wt.-% of a 30% potash water glass solution and 17 wt.-% of a silica sol of a particle size of approx. 9 nm and a solids content of 20% which has a mol ratio of 10 mol of SiO₂ per mol of potassium oxide is placed into a vessel and 10.5 wt.-% of iron oxide are dispersed therein at the dissolver for 5 minutes.

Then 29.3 wt.-% of a layered silicate mixture (kaolinite, muscovite, chlorite) and 6 wt.-% of 2-ethylhexylacrylate-methyl methacrylate copolymer (as a 50% dispersion in water) are added and homogenised. After stirring in 0.2 wt-% of bentonite, 0.1 wt.-% of xanthan gum and 1.5 wt.-% of an aminofunctional polydimethylsiloxane emulsion (Wacker 851 306) the mixture is adjusted to a consistency ready for processing with 31.6 wt.-% of water.

Application

The undercoat described above is applied to planed pinewood planks by means of a brush or through the Airless method. After 24 hours of drying at standard climatic conditions (23° C. and 50% r.h.), the planks are coated with the above silicate paint by means of a brush or a roller.

A wood sample thus prepared was first stored at standard climatic conditions for two weeks and then subjected to a short weathering test according to DIN EN 927-6. After expiry of the 2000 hours testing period described in the industry standard, the coating was still completely intact.

### COMPARATIVE EXAMPLE 1

The silicate paint 1 described above was applied directly to the planed pinewood planks without prior application of an undercoat. The wood sample thus prepared was then stored for two weeks under standard climatic conditions as described in example 1 and then tested in a short weathering test as set forth in DIN EN 927-6.

After 48 hours of short weathering, paint that had peeled off along the grain of the wood was evident.

### COMPARATIVE EXAMPLE 2

The alkyd undercoat 1 described above is applied to planed pinewood planks by means of a brush or through the Airless method. After 24 hours of drying at standard climatic conditions (23° C. and 50% r.h.), the planks are coated according to DIN 18 363 2.4.1 with a commercial dispersion silicate paint of the following composition:
30 wt.-% of potash water glass having a molar ratio of SiO₂ to potassium oxide of 2.55
4 wt.-% of butyl acrylate/methyl methacrylate dispersion
10 wt.-% of TiO₂
40 wt.-% of a filler mixture of calcium carbonate and mica
Remainder water

A wood sample thus prepared was stored at standard climatic conditions for two weeks as described in example 1 and then subjected to a short weathering test according to DIN EN 927-6.

After 500 hours, considerable bleaching and leaching as well as severe chalking was evident.

### COMPARATIVE EXAMPLE 3

In another comparative test, a commercial alkyd paint system (Xyladecor transparent wood protection agent) was applied twice to planed pinewood planks with a brush. The wood sample was then stored for two weeks at standard climatic conditions as described in example 1 and then subjected to a short weathering test according to DIN EN 927-6.

After 500 hours, severe dark discoloration was evident, and after 2000 hours the coating had weathered almost completely.

### EXAMPLE 2

Alkyd Undercoat 2

50 wt.-% of alkyd resin on a tall oil fatty acid basis (Uralac AD97, manufacturer DSM NeoResins) are diluted with 39.99 wt.-% of white spirit (Varsol 40, manufacturer Exxon Mobil Chemical). 10 wt.-% of silicic acid (Acematt HK 125, manufacturer Evonik) are added to this mixture. 0.01 wt.-% of cobalt-2-ethyl hexanoate are added as desiccant.

Silicate Paint 2

22 wt.-% of a filler (chlorite-quartz-mica intergrowth) and 10 wt.-% of titanium dioxide are dispersed with 23 wt.-% of water. 2 wt.-% of tetramethylammonium hydroxide (25% in water) are added, followed by the addition of 7 wt.-% of a 50% aqueous dispersion of a butyl acrylate methyl methacrylate copolymer.

A mixture of 18 wt.-% of silica sol (particle size 5 to 8 nm, solids content 30 wt.-%) and 6 wt.-% of a 29% potash water glass solution is stirred into the vessel. After dispersing, 10 wt.-% of a polysaccharide solution (solids content 5 wt.-%) are added. As an additional additive, 2 wt.-% of a 50% emulsion of an aminoalkyl-substitued polydimethyl siloxane are added.

Application

The undercoat described above is applied to planed pinewood planks by means of a brush or through the Airless method. After 24 hours of drying at standard climatic conditions (23° C. and 50 r.h.), the planks are coated with the above-mentioned silicate paint by means of a brush or a roller.

The pinewood planks thus produced were stored at standard climatic conditions for two weeks and then subjected to weathering as described in DIN EN 927-3. After expiry of the test period of one year prescribed by the industry standard, no peeling or other damages to the paint were evident.

### COMPARATIVE EXAMPLE 4

The silicate paint 2 described above was applied directly to the planed pinewood planks without prior application of an undercoat. The wood sample thus prepared was stored at standard climatic conditions for two weeks and then subjected to weathering according to DIN EN 927-3.

After 7 days, peeling was registered along the wood grain.

### COMPARATIVE EXAMPLE 5

Pinewood planks were coated with an alkyd resin undercoat (DELTA Impragniergrund 1.02) which does not contain any mineral fillers and dried for 24 hours. Then, the planks were coated with the above mentioned silicate paint 2. After two weeks of drying at standard climatic conditions, cross-cut tests were carried out in accordance with EN 927-3, Appendix C. The silicate paint peeled off practically along the entire length of the cut.

1. A compound coating for wood, comprising
an alkyd resin undercoat obtainable by applying an alkyd resin coating material (A) to the wood and allowing it to dry, and
a siliceous coating obtainable by applying a siliceous coating material (B) on top of the alkyd resin undercoat,
said coating materials (A) and (B) having the following compositions:
(A) Alkyd resin coating material, comprising:
(A-1) a long oil alkyd resin having an oil length of at least 60% and an iodine number of the oil of 100 or more;
(A-2) a mineral component;
(A-3) a solvent;
(B) Siliceous coating materials, comprising
(B-1) water glass or a mixture of silica sol and water glass, wherein the molar ratio of SiO₂ to alkali oxide is 5 to 30 mol of SiO₂ per mol of alkali oxide; and
(B-2) a mineral component.

2. A compound coating according to claim 1 wherein the alkyd resin coating material (A) additionally contains a desiccant (A-4).

3. A compound coating according to claim 1 or 2 wherein the iodine number of the oil in component (A-1) is at least 160.

4. A compound coating according to one or more of the claims 1 to 3 wherein component (A-2) is contained in an amount of 10 to 40 wt.-% based on the weight of component (A-1).

5. A compound coating according to one or more of the claims 1 to 4 wherein the molar ratio of SiO₂ to alkali oxide in component (B-1) is 15 to 25 mol of SiO₂ per mol of alkali oxide.

6. A compound coating according to one or more of the claims 1 to 5 wherein the alkali oxide in component (B-1) is potassium oxide.

7. A compound coating according to one or more of the claims 1 to 6 wherein the silica sol in component (B-1) has a mean particle size of <10 nm.

8. A compound coating according to one or more of the claims 1 to 7 wherein component (B-2) comprises one or more fillers selected from calcite, layered silicates and barite.

9. A compound coating according to one or more of the claims 1 to 8 wherein the siliceous coating material (B) further contains a polymer (B-3).

10. A compound coating according to claim 9 wherein the polymer (B-3) is a (meth)acrylate homopolymer or copolymer.

11. A compound coating according to claim 10 wherein the polymer (B-3) is contained in a ratio of 3 to 10 wt.-% based on the weight of component (B).

12. A compound coating according to one or more of the claims 1 to 11 wherein the siliceous coating material (B) further contains an organic ammonium compound (B-4).

13. Use of the combination of an alkyd resin coating material (A) and a siliceous coating material (B) as defined in one or more of the claims 1 to 12 for coating wood wherein the alkyd resin coating material (A) is used to prepare an undercoat for the siliceous coating material (B).

14. Method for preparing the compound coating according to one or more of the claims 1 to 12 comprising the following steps:
1. priming the wood by applying and allowing to dry one or more layers of the alkyd resin coating material (A),
2. applying and allowing to dry one or more layers of the siliceous coating material (B) on top of the undercoat.

15. A compound coating kit comprising the alkyd resin coating material (A) and the siliceous coating material (B) as defined in one or more of the claims 1 to 12 wherein the coating materials (A) and (B) are spatially separated.
